(19) United States
(12) Patent Application Publication
(10) Pub. No.: US 2012/0261325 A1
(43) Pub. Date: Oct. 18, 2012

(54) Filter Assembly Locking Mechanism and Method of Using Same

(75) Inventors: Nicholas William Brown, Kernersville, NC (US); Joe Wallace Todd, Bassett, VA (US)

(73) Assignee: PUROLATOR FACET, INC., Greensboro, NC (US)

(21) Appl. No.: 13/085,095

(22) Filed: Apr. 12, 2011

(51) Int. Cl. B01D 35/30; B23P 19/00; B01D 35/00

(52) U.S. Cl. 210/236; 210/232; 29/428

(57) ABSTRACT

A filter assembly includes a filter head with a first thread. The filter head has an inlet port and outlet port. The filter assembly includes a filter bowl including a second thread that screws on and off the first thread between mounted and unmounted positions. A filter element, housed in the filter bowl is in communication with the inlet port and outlet ports. The filter element is disposed along a flow path running from the inlet port to the outlet port. The filter assembly further includes a locking collar having a first catch acting upon a second catch provided by one of the filter head and the filter bowl in order to lock the filter bowl to the filter head in the mounted position. In an embodiment, the catches are adapted to be disengaged to allow rotation of the filter bowl from the mounted position to the unmounted position.

### FIELD OF THE INVENTION

This invention generally relates to filter assemblies such as those suitable for use in hydraulic systems, particularly aircraft hydraulic systems.

### BACKGROUND OF THE INVENTION

There are a number filter systems used in a range of applications where it is necessary to remove impurities from a fluid. Conventional hydraulic systems typically include filter assemblies a filter bowl which houses a filter element. The filter bowl typically attaches to a filter head assembly, which typically includes an input and an output for the flow of hydraulic into and away from the filter element. Some of these conventional systems allow for the removal of the filter bowl to allow for replacement of the filter element when the filter element becomes saturated with impurities.

The present invention is directed towards improvements over the state of the art, and particularly to the attachment mechanisms between a filter head assembly and filter bowls. These and other advantages of the invention, as well as additional inventive features, will be apparent from the description of the invention provided herein.

### BRIEF SUMMARY OF THE INVENTION

In one aspect, embodiments of the invention provide a filter assembly that includes a new locking mechanism. The filter assembly includes a filter head with a first thread. The filter head has an inlet port and an outlet port. The filter assembly also includes a filter bowl including a second thread that screws on and off the first thread between a mounted position and an unmounted position, respectively. A filter element, at least partially enclosed by the filter bowl, is in communication with the inlet port and the outlet port. The filter element contains a filter media for filtering fluid. In a particular embodiment, the filter element is disposed along a flow path running from the inlet port to the outlet port. The filter assembly further includes a locking collar having a first catch acting upon a second catch provided by one of the filter head and the filter bowl in order to lock the filter bowl to the filter head in the mounted position. In an embodiment, the catches are adapted to be disengaged to allow rotation of the filter bowl from the mounted position to the unmounted position.

In another aspect, embodiments of the invention provide a method of attaching a filter bowl assembly to a filter head assembly. The method includes providing a locking mechanism configured to securely attach a filter bowl to a filter head assembly, and providing, during the locking mechanism attachment process, a visual indicator, an audible indicator, and a tactile indicator to indicate that the locking mechanism is properly engaged. In a particular embodiment, such indication that the locking mechanism is properly engaged means that the filter bowl is threaded into the filter head assembly sufficiently to prevent the filter bowl from inadvertently detaching from the filter head assembly such that the filter bowl does not work loose from the filter head assembly by means of aircraft vibration, for example, or other means.

In yet another aspect, embodiments of the invention provide a filter assembly that includes a filter bowl having a threaded portion, and a filter head assembly having a threaded portion configured to receive the threaded portion of the filter bowl. In a particular embodiment, the filter assembly also includes a collar configured to attach to one of the filter head assembly and the filter bowl. In a more particular embodiment, the collar has a first locking portion configured to engage the other of the filter head assembly and the filter bowl. This engagement is configured to prevent detachment of the filter bowl from the filter head assembly.

Other aspects, objectives and advantages of the invention will become more apparent from the following detailed description when taken in conjunction with the accompanying drawings.

### BRIEF DESCRIPTION OF THE DRAWINGS

The accompanying drawings incorporated in and forming a part of the specification illustrate several aspects of the present invention and, together with the description, serve to explain the principles of the invention. In the drawings:

FIG. 1 is a plan view of the filter system with locking mechanism, constructed in accordance with an embodiment of the invention;

FIG. 2 is a pictorial view of a locking collar spring adapted to be incorporated into an embodiment of the invention;

FIG. 3 is a pictorial view of a wave spring adapted to be incorporated into an embodiment of the invention;

FIG. 4 is a pictorial view of a retainer adapted to be incorporated into an embodiment of the invention;

FIGS. 5A-5C are exploded assembly views of the filter bowl with components of the locking mechanism showing progressive assembly of the locking collar, according to an embodiment of the invention;

FIG. 6 is a close-up view of the locking mechanism constructed in accordance with an embodiment of the invention;

FIGS. 7A-7C are pictorial views of the filter assembly with locking mechanism showing operational features thereof relating to servicing of the filter assembly as might be done by a mechanic; and

FIG. 8 is a pictorial view of the filter head assembly of FIGS. 7A-7C.

While the invention will be described in connection with certain preferred embodiments, there is no intent to limit it to those embodiments. On the contrary, the intent is to cover all alternatives, modifications and equivalents as included within the spirit and scope of the invention as defined by the appended claims.

### DETAILED DESCRIPTION OF THE INVENTION

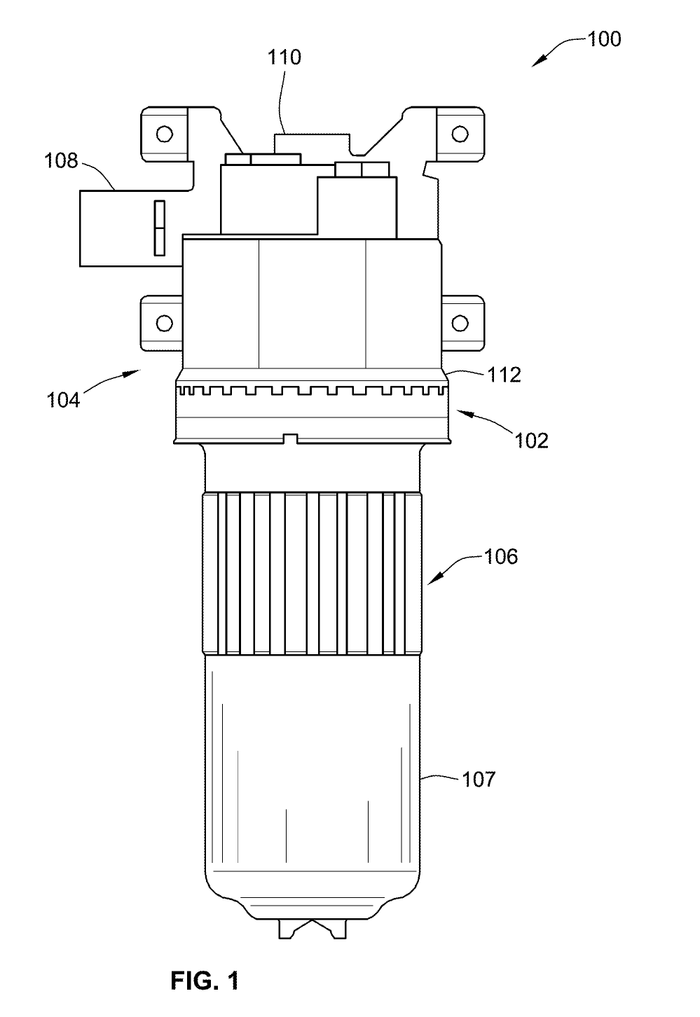

FIG. 1 is a pictorial view of a filter assembly 100 incorporating a locking mechanism 102 according to an embodiment of the invention. Embodiments of the filter assembly 100 provide an example of the type of filter assembly that might be found in the hydraulic system of an aircraft. However, one of ordinary skill in the art will recognize that filter assembly 100 is not limited to such uses, and could be found in any number of hydraulic systems or could be used for the filtering of fluids other than hydraulic. The locking mechanism 102 serves to secure attachment of filter head assembly 104 to filter bowl assembly 106. The filter bowl assembly includes filter bowl 107, and a replaceable filter element 115 having filter media to remove impurities from fluids such as hydraulic or lubricating oil, for example.

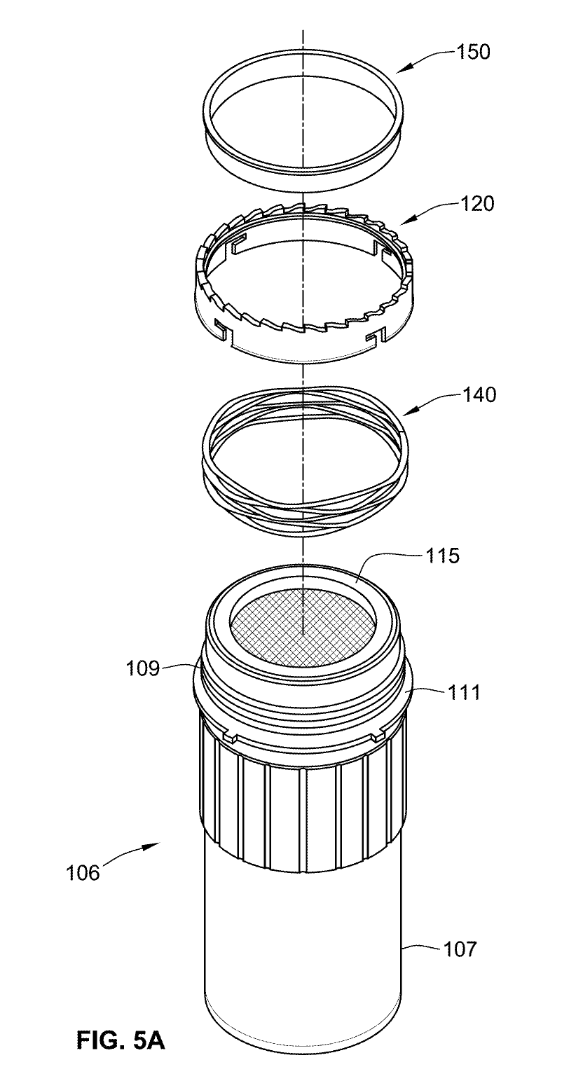

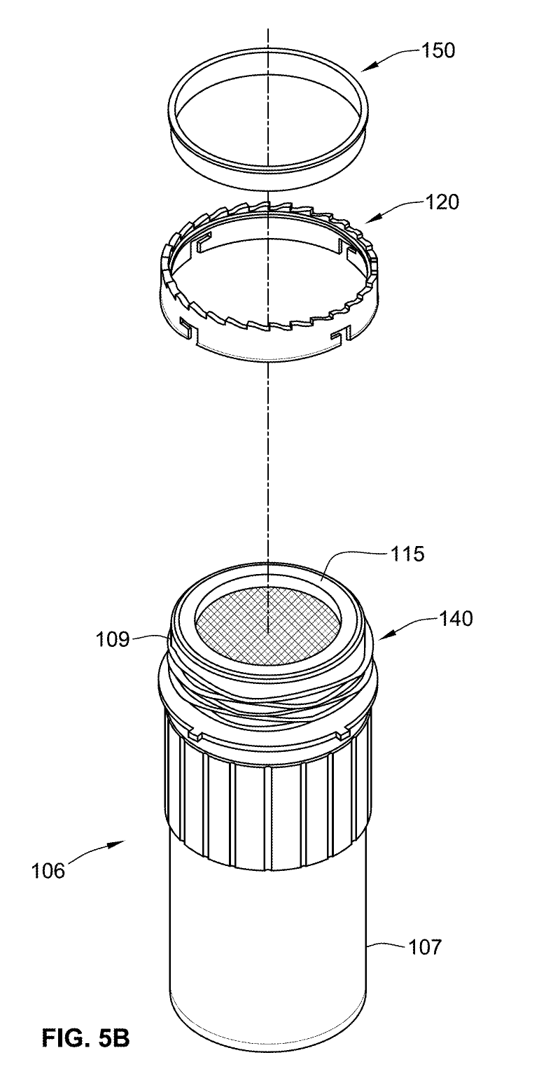

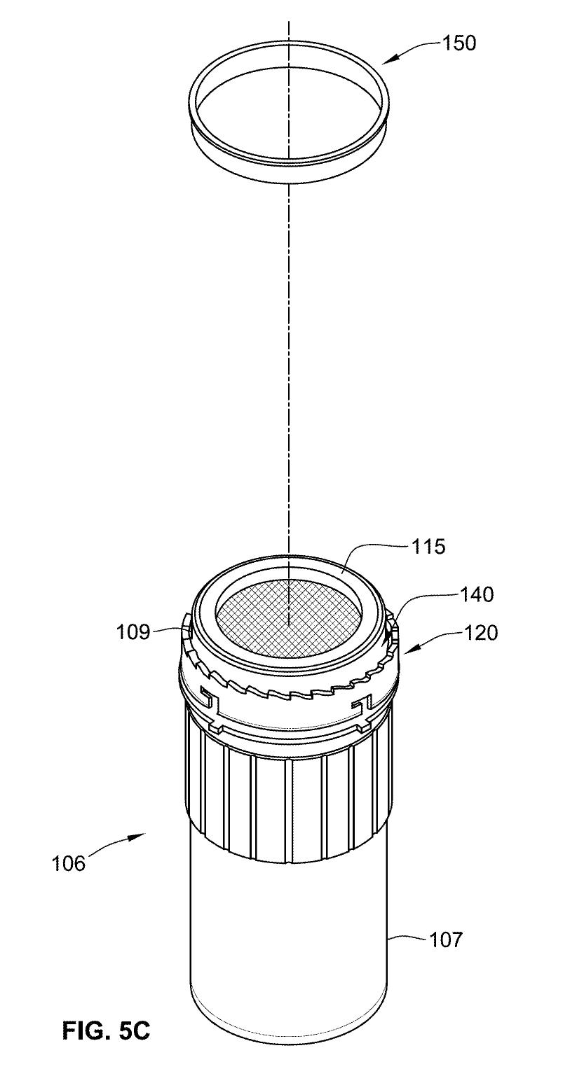

The filter head assembly 104 includes an inlet 108 and an outlet 110. In a hydraulic system, for example, the hydraulic would flow into inlet 108 through the filter element 115 and filtered hydraulic would out through outlet 110. In a particular embodiment of the invention, the filter head assembly 104 has a substantially cylindrical portion 112. In a more particular embodiment, the inner surface of the cylindrical portion 112 is threaded such that the cylindrical portion 112 is configured to receive a threaded portion 109 (shown in FIG. 5A) on the filter bowl 107 of the filter bowl assembly 106. Below the threaded portion 109 on the filter bowl 107, there is a ledge 111 (shown in FIG. 5A) to support the components of the locking mechanism 102.

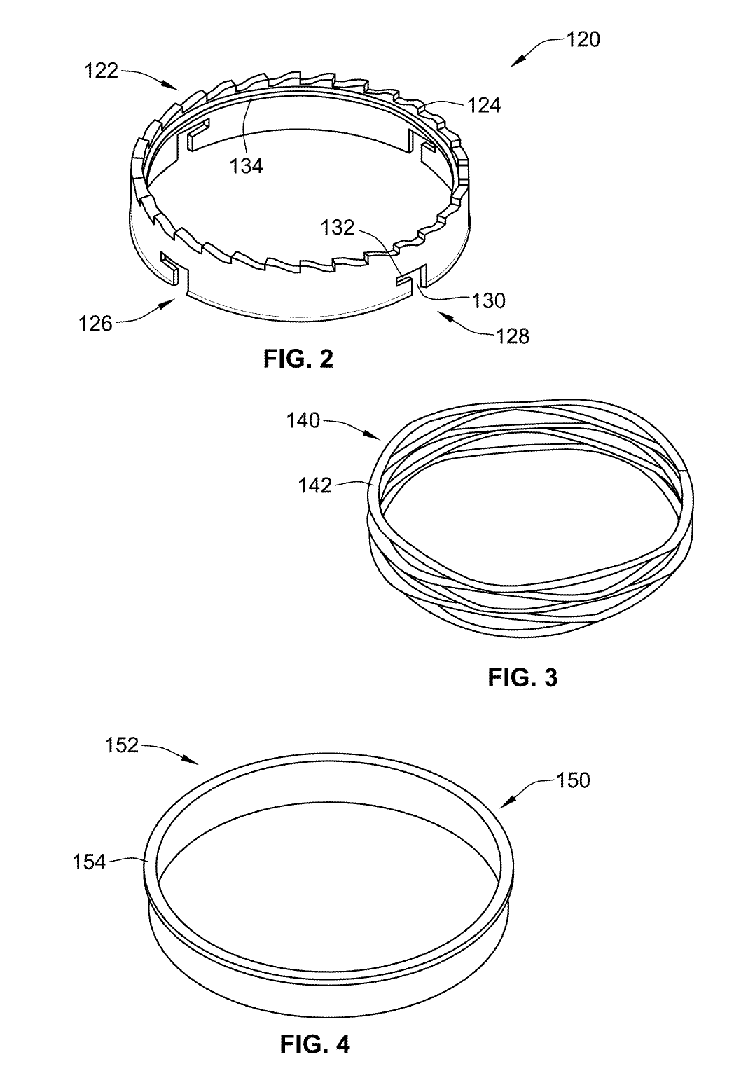

In an embodiment of the invention, the locking mechanism 102 includes collar 120, a biasing element, which, in the embodiment shown, is wave spring 140, and retainer 150. FIG. 2 is a pictorial view of a collar 120, constructed in accordance with an embodiment of the invention. In the exemplary embodiment of FIG. 2, the collar 120 is substantially cylindrical. At a first 122 end of the collar 120 are one or more catches, which may take the form of a ratchet wheel having teeth 124 disposed circumferentially that end of the collar 120. In a particular embodiment, a second end 126 of the collar 120 opposite the first end 122 has one or more slotted openings or slots 128 that may be used to provide a detent mechanism for holding the collar in an unlatched position. In a particular embodiment, these slots have a axial leg 130 and a radial leg 132. One or more detent tabs 113 projecting radially from an outer surface of the filter bowl 107 ride in the one or more slots 128 and can hold the collar 120 in the unlatched position when in the radial leg 132.

In particular embodiments, an inner surface of the collar 120 includes an annular lip 134 that projects radially inward. The lip interacts with other components of the locking mechanism 102 to keep the components in place. In particular embodiments, the collar 120 may be made of metal such as aluminum or steel or alloys thereof, but may also be made from non-metallic materials such as plastic.

FIG. 3 is a pictorial view of a wave spring 140 which can be incorporated into the embodiment of the invention shown in FIG. 1 and can serve to bias the collar 120 toward the latched position. In at least one embodiment, the wave spring 140 is made from a spirally wound annular member 142 that contains waves which provide the biasing force. The annular member 142 is configured such that it can be compressed in the axial direction.

In embodiments of the invention, the wave spring 140 is made from a resilient, yet sufficiently rigid material such as stainless steel, aluminum, or alloys thereof. However, it is also envisioned that suitable non-metal materials including certain plastics and composites may be used in some applications.

FIG. 4 is a pictorial view of a retainer 150 which can be incorporated into the embodiment of the invention shown in FIG. 1. In a particular embodiment, the retainer 150 is annular. At one end 152 of the retainer, a lip 154 projects radially outward. In a particular embodiment, the retainer 150 is made from aluminum, stainless steel or alloys thereof. It is also envisioned that the retainer could be fashioned from a suitable non-metallic material such as plastic or ceramic. In an embodiment, the retainer 150 is press fit, glued, or otherwise fixedly secured to retain the collar 120 in place, while allowing for axial movement of the collar 120 between latched and unlatched positions.

FIGS. 5A-5C is an exploded pictorial view of the filter bowl assembly 106 and locking mechanism 102 according to an embodiment of the invention. The filter element is not shown in these figures. However, as can be seen in FIG. 5B, the wave spring 140 fits onto the filter bowl 107 just below the threaded portion 109. As shown in FIG. 5C, the collar 120 is assembled over the wave spring 140 onto the filter bowl assembly 106. The retainer 150 is inserted between the wave spring 140 and filter bowl 107.

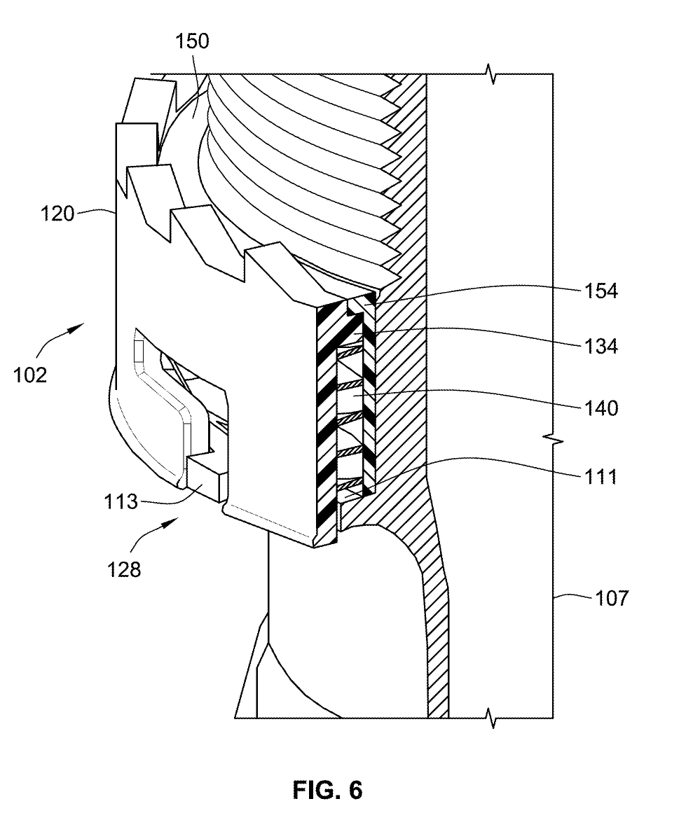

FIG. 6 illustrates a close-up view of the locking mechanism 102. The wave spring 140 is held in place supported by the ledge 111 of the filter bowl 107 on the bottom, and by the annular lip 134 of the collar 120 on the top. The bottom of retainer 150 is supported by ledge 111, while the lip 154 of the retainer 150 abuts the annular lip 134 of the collar 120. The retainer 150 is press fit onto the filter bowl 107, and serves to keep the wave spring 140 in place. In a particular embodiment of the invention, the filter bowl 107 includes one or more detent tabs 113, which act as a detent mechanism, configured to fit into the one more slots 128.

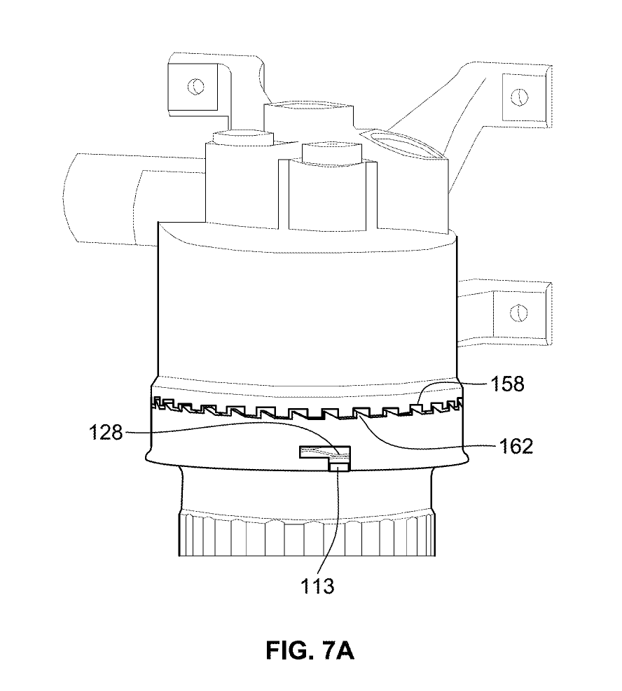

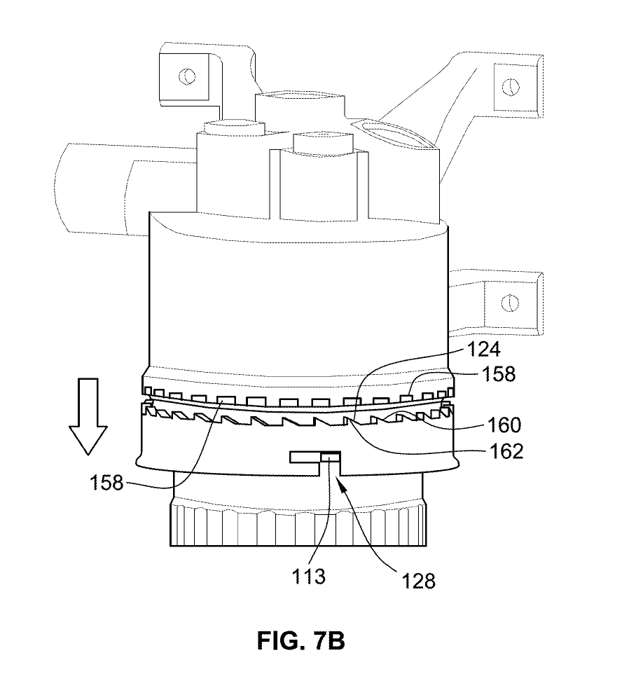

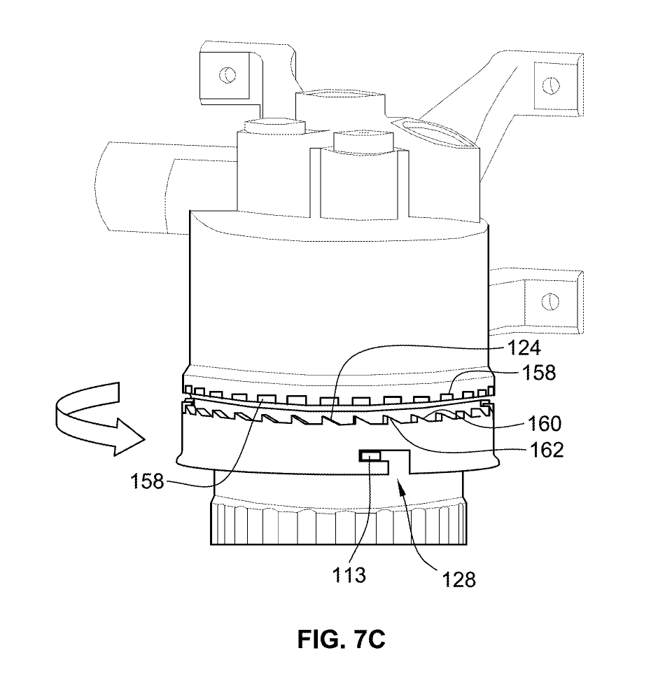

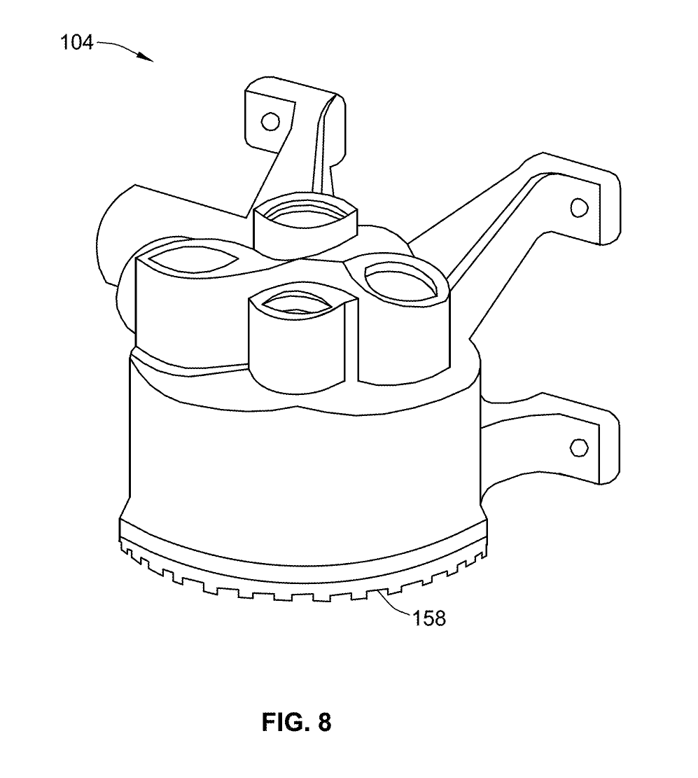

FIGS. 7A-7C illustrate the operational modes of the locking mechanism 102. In a particular embodiment the filter head assembly includes one or more catches that may take the form of teeth 158 configured to mate with the series of teeth 124 on the collar 120. In at least one embodiment, the series of teeth 124 on the collar 120 are substantially triangular with a ramped surface 160 and a vertical surface 162 such that when the series of teeth 124 on the collar 120 engages the series of catches 158 on the filter head assembly 106, the ramped surfaces 160 permit rotation of the collar 120, and therefore the filter bowl assembly 106 in one direction; the direction in which the filter bowl assembly 106 screws into the filter head assembly 104. The vertical surface 162 prevents the collar 120, and the filter bowl assembly 106, from rotating in the opposite direction thus preventing the filter bowl assembly 106 from unscrewing and detaching from the filter head assembly 104.

FIG. 7A shows the locking mechanism 102 engaged with the series of catches 124 on the collar engaged with the series of teeth 158 on the filter head assembly 104. FIG. 8 provides a pictorial view of the filter head assembly 104 showing teeth 158, input 108, and output 110. In the embodiment shown in FIG. 7A, when the locking mechanism 102 is engaged, the detent tab 113 is located at the bottom of the axial leg 130 of the slot 128 (shown in FIG. 2). In the embodiment shown, the collar 120 is slidable in an axial direction. Thus, to disengage the locking mechanism 102, the collar 120 must be pulled down, as shown in FIG. 7B, compressing the wave spring 140, which normally biases the collar 120 into engagement with the filter head assembly 104. Once pulled down, the collar 120 is rotated, as shown in FIG. 7C, such that the detent tab 113 is at or near the end of the radial leg 132 of the slot 128.

In particular embodiments of the invention, one or more components of the locking mechanism 102 are made to be visually distinctive from surrounding components such that there is an obvious visual indicator when the locking mechanism 102 is not properly engaged. For example, the retainer 150, or possibly the wave spring 140 could be made in a color easily distinguishable from that of surrounding components. When the locking mechanism 102 is properly engaged, the collar 120 would completely, or nearly completely, cover the retainer 150 and wave spring 140. Thus, if the easily distinguishable retainer 150 or wave spring 140 is visible, this would indicate to the user that the locking mechanism 102 is not properly engaged.

In this manner, the one or more detent tabs 113 serve to keep the collar 120 in the lowered position with the wave spring 140 in compression. With the collar 120 disengaged, the filter bowl assembly 106 can be unscrewed so that the filter element can be replace. When the filter element is replaced, the filter bowl assembly 106 is screwed into the filter head assembly 104 and the collar 120 is rotated so that the wave spring 140 urges the series of teeth 124 on the collar 120 into engagement with the series of teeth 158 on the filter head assembly 104. Because of the arrangement of the mating teeth 124, 158, when the locking mechanism 102 is engaged as described, there is an audible click when the teeth 124, 158 snap into alignment, which indicates to the user that the locking mechanism 102 is properly engaged. Further, there is a tactile indicator in that the user will normally be able to feel, as well as hear, the mating teeth 124, 158 snap into place.

While the locking mechanism 102 in the embodiments described above is on the filter bowl 107 with a corresponding structure on the filter head assembly 104, one of ordinary skill in the art will recognize that the locking mechanism may be configured to be on the filter head assembly 104 with the corresponding structure on the filter bowl 107. Certain claims appended hereto are meant to encompass both possibilities.

All references, including publications, patent applications, and patents cited herein are hereby incorporated by reference to the same extent as if each reference were individually and specifically indicated to be incorporated by reference and were set forth in its entirety herein.

The use of the terms “a” and “an” and “the” and similar referents in the context of describing the invention (especially in the context of the following claims) is to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

Preferred embodiments of this invention are described herein, including the best mode known to the inventors for carrying out the invention. Variations of those preferred embodiments may become apparent to those of ordinary skill in the art upon reading the foregoing description. The inventors expect skilled artisans to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

What is claimed is:

1. A filter assembly, comprising:
a filter head with a first thread, the filter head providing an inlet port and an outlet port;
a filter bowl including a second thread that screws on and off the first thread between a mounted position and an unmounted position, respectively;
a filter element, at least partially enclosed by the filter bowl, in communication with the inlet port and the outlet port, the filter element having a filter media for filtering fluid, the filter element disposed along a flow path running from the inlet port to the outlet port; and
a locking collar having a first catch acting upon a second catch provided by one of the filter head and the filter bowl to lock the filter bowl to the filter head in the mounted position, the catches adapted to be disengaged to allow rotation of the filter bowl from the mounted position to the unmounted position.

2. The filter assembly of claim 1, further comprising a detent mechanism configured to hold the locking collar in a latched position, wherein the detent mechanism is manually actuatable to release the catches and allow the filter bowl to be unscrewed to the unmounted position.

3. The filter assembly of claim 2, wherein the locking collar includes a ratchet wheel having a first plurality of teeth adapted to engage a corresponding second plurality of teeth included in one of the filter head and the filter bowl.

4. The filter assembly of claim 3, wherein a spring is arranged to urge the first and second plurality of teeth together.

5. The filter assembly of claim 4, further comprising an annular retainer securing the collar to the filter bowl, wherein the second plurality of teeth is defined by a generally cylindrical rim of the filter head, the cylindrical rim defining the first thread.

6. The filter assembly of claim 5, wherein the spring is an annular wave spring supported by an annular shoulder extending around the filter bowl and urging the collar toward the filter head, the collar being axially slidable over the outer periphery of the filter bowl and against the action of the wave spring to disengage the first and second plurality of teeth when in the mounted position.

7. The filter assembly of claim 6, wherein the detent mechanism comprises a detent slot on the collar having an axial leg and a radial leg, and a detent tab extending radially outward from the filter bowl, the detent tab configured to slide within the detent slot along the axial leg and the radial leg, the collar having an axially extended position with the first and second plurality of teeth engaged wherein the detent tab is not in the radial leg, and an axially retracted position in which the wave spring is compressed with the detent tab positioned in the radial leg of the detent slot.

8. The filter assembly of claim 6, wherein the first and second catches act as a one way clutch, allowing rotation proximate the mounted position in only one rotational direction.

9. The filter assembly of claim 8, wherein the second plurality of teeth are regularly spaced around the generally cylindrical rim with notches defined between adjacent teeth, the first plurality of teeth adapted to be received within the notches, wherein the first plurality of teeth have a ramp surface on one side and stop surface on the other side, wherein rotation in a first direction toward the mounted position causes engagement between the ramp surfaces of the first plurality of teeth with the second plurality of teeth causing the collar to slide axially away from the filter head against the action of the wave spring and allowing continued movement toward the mounted position, and wherein rotation in a second direction opposite the first direction causes the stop surfaces of the first plurality of teeth to engage with corresponding stop surfaces on second plurality of teeth to prevent rotation in the second rotational direction, at least when the collar is in the extended position.

10. The filter assembly of claim 9, wherein the annular retainer comprises a ring portion press fit and/or glued on a corresponding cylindrical surface defined by the filter bowl, the wave spring surrounding the ring portion with the locking collar surrounding the wave spring, the annular retainer further having a retention flange projecting radially outward from the ring portion acting upon a radially inward flange formed along an inner surface of the locking collar.

11. A method of attaching a filter bowl assembly to a filter head assembly comprising:
providing a locking mechanism configured to securely attach a filter bowl to a filter head assembly;
providing, during the locking mechanism attachment process, a visual indicator, an audible indicator, and a tactile indicator to indicate that the locking mechanism is properly engaged, wherein such indication means that the filter bowl is threaded into the filter head assembly sufficiently to prevent the filter bowl from inadvertently detaching from the filter head assembly.

12. The method of claim 11, wherein providing a locking mechanism comprises providing a collar with a first locking portion that is configured to engage a second locking portion on one of the filter head assembly and the filter bowl assembly such that, when the first and second locking portions are engaged, the filter bowl assembly is prevented from detaching from the filter head assembly.

13. The method of claim 12, wherein providing a locking mechanism further comprises providing a spring configured to bias toward engaging one of the filter head assembly and filter bowl assembly.

14. The method of claim 12, wherein providing a locking mechanism further comprises providing a retainer configured to keep the spring in place during operation of the locking mechanism.

15. The method of claim 12, wherein providing a visual indicator comprises making a component of the locking mechanism visually distinctive from its surrounding components such that a portion of the locking mechanism is visible only when the locking mechanism is not properly engaged.

16. The method of claim 12, wherein providing a locking mechanism comprises configuring the filter bowl assembly and filter head assembly with threaded portions such that the two assemblies can be screwed together, and wherein screwing the filter bowl and filter head assemblies together causes the collar to engage a portion of the filter head assembly to prevent unscrewing of the two assemblies.

17. The method of claim 12, wherein providing a locking mechanism comprises configuring the filter bowl assembly and filter head assembly with threaded portions such that the two assemblies can be screwed together, and wherein screwing the filter bowl and filter head assemblies together causes the collar to engage a portion of the filter bowl assembly to prevent unscrewing of the two assemblies.

18. The method of claim 12, wherein providing a audible indicator comprises configuring the first locking portion and second locking portion to make one or more audible clicks when the locking mechanism is properly engaged.

19. The method of claim 11, wherein providing a locking mechanism comprises providing a collar configured to be removably attached to one of the filter head assembly and the filter bowl assembly.

20. The method of claim 19, wherein the collar includes one or more slotted portions configured to receive a tab on one of the filter head assembly and the filter bowl assembly.

21. A filter assembly comprising:
a filter bowl having a threaded portion;
a filter head assembly having a threaded portion configured to receive the threaded portion of the filter bowl; and
a collar configured to attach to one of the filter head assembly and the filter bowl, the collar having a first locking portion configured to engage the other of the filter head assembly and the filter bowl, the engagement configured to prevent detachment of the filter bowl from the filter head assembly.

22. The filter assembly of claim 1, wherein the filter bowl includes a plurality of tabs and the collar includes a corresponding slot for each of the plurality of tabs, and wherein mating the slots to the tabs serves to secure the collar to the filter bowl.

23. The filter assembly of claim 1, wherein the collar is cylindrical with a first set of interlocking teeth disposed at one end, the first set of interlocking teeth configured to engage a second set of interlocking teeth on the filter head assembly to prevent detachment of the filter bowl from the filter head assembly.

24. The filter assembly of claim 1, further comprising a wave spring disposed between the filter bowl and the collar, the wave spring configured to bias the collar into a locking position.

25. The filter assembly of claim 4, further comprising a retainer disposed between the filter bowl and the wave spring, the retainer configured immobilize the wave spring and collar.
